(19) United States
(12) Patent Application Publication
(10) Pub. No.: US 2026/0099774 A1
(43) Pub. Date: Apr. 9, 2026

(54) HYBRID PARSER AND MACHINE-LEARNING-BASED EXTRACTION OF COMMERCIAL FLIGHT BOOKINGS AND MATCHING TO EMPTY LEG SHARED CHARTERS

(71) Applicant: Revaire Inc., Miami, FL (US)

(72) Inventors: Harrison Epstein, Miami, FL (US); Lucas C. McNees, Marina del Ray, CA (US); Gregory Scott Whitescarver, Los Angeles, CA (US); Justin Giovanni Baldwin, Los Angeles, CA (US); Boban Lukic, Belgrade (RS); Bruno Kecman, Zagreb (RS)

(21) Appl. No.: 19/349,287

(22) Filed: Oct. 3, 2025

Related U.S. Application Data
(60) Provisional application No. 63/703,407, filed on Oct. 4, 2024.

(51) Int. Cl. G06Q 10/02; G06F 40/205; G06N 20/00; G06Q 10/109; H04L 67/55

(52) U.S. Cl. CPC G06Q 10/02; G06F 40/205; G06N 20/00; G06Q 10/109; H04L 67/55

(57) ABSTRACT

An online shared charter platform automatically extracts and utilizes commercial flight information to surface private empty-leg opportunities. The platform accesses user-associated data objects from external data platforms and identifies commercial flight bookings. A template-based parser set attempts deterministic extraction of structured flight attributes using keyword matching, regular expressions, and structured-markup queries. If validated extraction fails, a machine-learned model, guided by a structured data template specifying field types and normalized airport and timestamp formats, generates a conformant structured result. The platform stores parser-or model-based attributes as a structured commercial flight dataset. A matching engine compares the dataset to available empty leg flights using at least one of geographic clustering of airports into metropolitan areas or dual time-window constraints including departure and arrival windows, and, when a match satisfies configured criteria, transmits a notification with the available empty leg flight to the user's client device.

### CROSS REFERENCE TO RELATED APPLICATION

This application claims a benefit of, and priority to, U.S. Patent Application 63/703,407, filed Oct. 4, 2024, the contents of which is incorporated by reference in its entirety.

### TECHNICAL FIELD

The present disclosure relates generally to computer-implemented collection and normalization of commercial air travel booking information from external data platforms, and more particularly to a hybrid parser and machine-learning based extraction pipeline that generates structured travel data for use by matching engines to identify empty leg shared charter opportunities and drive operator/user notifications on networked computing systems.

### BACKGROUND

Private aviation suffers from substantial inefficiencies arising from underutilized flights (“empty legs”), including ferry segments and repositioning flights that operate without passengers. These segments consume fuel, crew time, and maintenance cycles yet generate no revenue and increase environmental impact. Industry estimates suggest empty legs constitute a material fraction of private jet movements.

Conventional approaches for utilizing empty legs and assembling shared charters are operationally manual and computationally inefficient. Travelers are often required to search listings, upload itineraries, or self-report demand windows; operators must sift through inconsistent incoming requests from disparate sources. These workflows cause unnecessary network usage and compute cycles due to repeated polling and human-driven checks for availability and frequently fail to surface viable opportunities at the right time.

From a computing perspective, the core data needed to automate this process, commercial flight bookings (or event bookings) of potential passengers, resides in heterogeneous, third-party systems (e.g., email and calendar services) and arrives in highly variable formats (multi-part MIME, HTML tables, free-text bodies, PDFs, image attachments). Airline and travel-agency confirmations do not share a common schema, with field labels, ordering, and markup differing across providers and changing over time. These variations defeat existing solutions and lead to missing or malformed fields (e.g., flight numbers, origin/destination, departure/arrival times, passenger data), creating high false-negative/false-positive rates in conventional extraction pipelines.

Further, deploying solutions against third-party data platforms adds concrete systems constraints, such as requirements to support push and pull access, to conform to provider rate limits, to incrementally sync updates with deduplication, to enforce least-privilege authorization, and so on. Without robust mechanisms to handle these constraints while accessing, validating, normalizing, and comparing booking data to variably specified empty leg supply, systems overuse network and compute, surface stale or incorrect opportunities, and require manual intervention.

### BRIEF DESCRIPTION OF THE DRAWINGS

FIG. 1 illustrates an example system environment for an online shared charter platform, in accordance with one or more embodiments.

FIG. 2 is a block diagram of an online shared charter platform, in accordance with one or more embodiments.

FIG. 3 is a block diagram illustrating generation of structured commercial flight data by a hybrid extraction pipeline of the online shared charter platform, in accordance with one or more embodiments.

FIGS. 4A-4B show examples of structured commercial flight data generated respectively by a template-based parser and a machine-learned model of an online shared charter platform, in accordance with one or more embodiments.

FIGS. 5A-5F are example illustrations of graphical user interfaces (GUIs) provided by the online shared charter platform for matching a user's commercial flight to a private flight and booking the private flight, in accordance with one or more embodiments.

FIG. 6 is a flowchart for a method of automatically matching a user's commercial flight to an identified private flight, in accordance with one or more embodiments.

FIG. 7 is a flowchart for a method of creating bespoke shared charters, in accordance with one or more embodiments.

FIG. 8 is a block diagram illustrating components of an example machine for reading and executing instructions from a machine-readable medium, in accordance with one or more example embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated may be employed without departing from the principles described herein.

### Configuration Overview

This disclosure pertains to a hybrid data extraction pipeline for automatically and accurately extracting commercial flight bookings or event bookings from linked user accounts and executing an automated matching process to identify and surface private flights (e.g., empty leg shared charters, empty leg full aircraft charters, bespoke shared charters) to users that may be interested in booking. Traveler booking information (e.g., commercial flight booking, event booking confirmation) may be dispersed across heterogeneous external services and expressed in volatile, provider-specific formats that lack a common schema. Also, private aviation operator supply may be specified as flexible constraints (e.g., departure windows and durations) rather than fixed schedules, which complicates automated comparison and identification of matched opportunities.

Techniques disclosed herein address these obstacles by orchestrating and implementing a data extraction pipeline that generates structured and normalized commercial flight or event data using hardcoded template-based parsers with a machine-learned model as a fallback, performing constraint-aware matching over geographic clusters and temporal windows, and generating operator and user notifications for identified matches. In some embodiments, the platform includes a data-access layer configured to obtain a data object associated with a user from an external data platform. The data-access layer may support multiple access modes, including: (i) subscription to provider notification channels; (ii) authenticated API queries that apply search parameters over message or event metadata and content; and (iii) authenticated retrieval using user-granted credentials or delegated tokens. Commercial flight or event bookings may be identified from the accessed data objects. In some embodiments, this process may use one or more of subject/title keywords, sender/organizer domains associated with airlines or travel providers, body/description patterns, and markup signatures indicative of itinerary content.

The platform may employ an extraction pipeline to extract a standardized structured commercial fight dataset from the data objects using a plurality of provider-specific parsers. A parser of the set of parsers may be selected based on signals such as domain, subject/title, body text patterns, or markup structure. The selected parser may apply deterministic extraction rules (e.g., lexical normalization and tokenization; keyword and n-gram matching; anchored regular-expression capture; and structured-markup traversal via DOM navigation) to obtain per-leg flight attributes. Extracted values may be validated against a predefined schema that specifies required fields and permissible values. For example, in the case of a commercial flight booking, the extracted values may include the date and time of the flight, arrival airport, and departure airport. In the case of an event booking, the extracted values may include the date, time and location of the event.

To accommodate format variability and provider drift, the pipeline may employ a validated-failure trigger. When parser output does not satisfy the schema, a machine-learned extraction module may be invoked. In some embodiments, the machine-learned model may be conditioned by a structured data template that defines field names and types, required/optional status and cardinality, and nested departure and arrival structures. The model may generate a structured output that may be checked against the template, with validation or targeted regeneration for any nonconforming fields.

The platform may store the resulting structured commercial flight dataset (comprising parser-based or model-based attributes) in a datastore. An operator-facing supply subsystem of the platform may maintain empty leg records that may include route endpoints, a departure window, a duration value, operational attributes, and operator-configurable constraints (e.g., minimum revenue thresholds). The platform may further include a matching engine that compares the structured commercial flight dataset to the empty leg supply. In performing the matching, the matching engine may define geographic clusters of proximate airports (e.g., metropolitan-area groupings) to support location-tolerant matching. The matching engine may further employ dual time-window constraints that consider both departure and arrival timing in determining whether a given empty leg is a match for a given commercial flight booking. That is, for empty leg records defined by a departure window and duration, the engine may derive a corresponding arrival interval and evaluate both departure and arrival windows when testing candidate matches. When multiple member bookings satisfy constraints for a single empty leg, the matching engine may compute a proposed departure time for the private flight from the candidate set and constrain or round that proposal to an operational interval within the empty leg window. The engine may exclude bookings flagged as ignored or already matched and evaluate operator constraints before surfacing an opportunity.

The platform may further include modules that automate flight creation. For example, a flight opportunity record may be created that captures identifiers for the matched empty leg and member bookings, the proposed schedule, and status/expiration metadata. A notification subsystem may transmit operator-facing notifications with a reference to the opportunity. Responsive to operator approval (when required) or to configuration permitting automatic progression, the subsystem may issue user-facing notifications that enable review and booking, and may schedule reminder messages aligned to opportunity state transitions. By integrating extraction pipelines with flight matching and flight creation capabilities, the platform provides a technical solution to a technology-rooted problem: it reliably acquires heterogeneous third-party (flight or event) booking data, converts that data into a validated structured form, and performs constraint-aware matching against variably and dynamically specified empty leg or bespoke shared charter supply, thereby reducing unnecessary network and compute usage and improving the timeliness and correctness of surfaced opportunities.

### Example System Environment

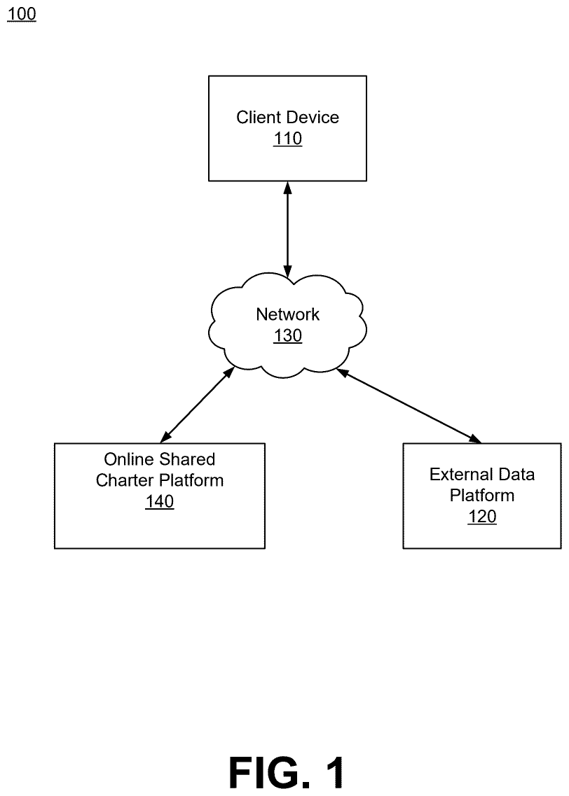

FIG. 1 illustrates an example system environment 100 for an online shared charter platform 140, in accordance with one or more embodiments. The system environment 100 illustrated in FIG. 1 includes a client device 110, an external data platform 120, a network 130, and an online shared charter platform 140. Alternative embodiments may include more, fewer, or different components from those illustrated in FIG. 1, and the functionality of each component may be divided differently from the description below. While one client device 110, and one external data platform 120 are illustrated, any number of such devices or systems may be connected and operate concurrently within the environment 100.

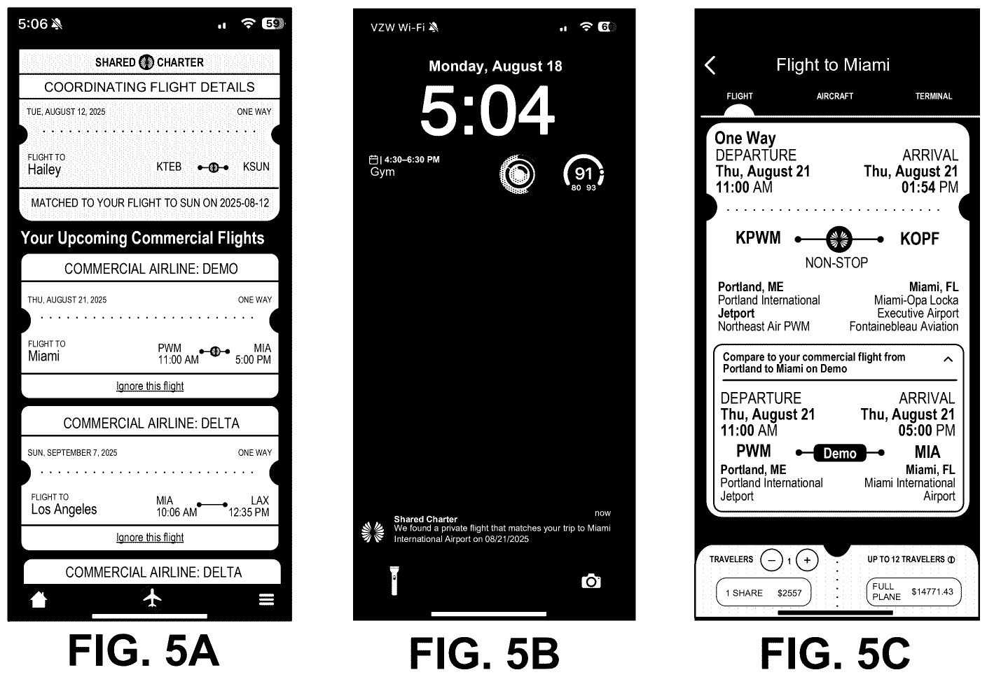

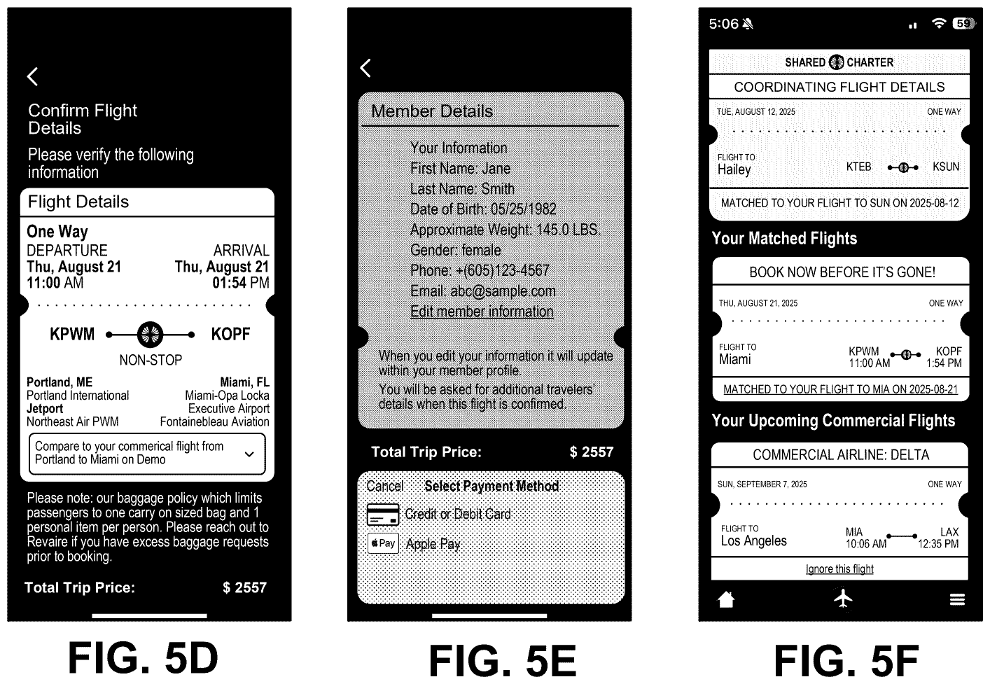

Each client device 110 may be a client device through which a user may interact with the platform 140. The client device 110 can be a personal or mobile computing device, such as a smartphone, a tablet, a laptop computer, or desktop computer. In some embodiments, the client device 110 executes a client application that uses an application programming interface (API) to communicate with the online system 140. A user of the client device may be a member (e.g., customer, traveler) of the online system 140 who interacts with the online system 140 to, e.g., view a notification of a matched shared charter flight, browse available shared charter flights, view available flight details, book a shared charter flight, and the like. The user may also be a charter flight operator who interacts with the online system 140 to, e.g., input flight information for the operator's fleet, identify empty legs or underutilized fleet capacity, approve creation of shared charter flights, and the like. The charter flight operator may also be able to use the data gleaned from interacting with the online system 140 to run their fleet more efficiently by, e.g., scheduling additional flights based on realized demand for shared charter flights or bespoke charter flights. Each client device 110 presents an interface of the online shared charter platform 140 to the user. The interface is a user interface (e.g., FIGS. 5A-5F) that the user can use to interact with the online system 140. The interface may be part of a client application operating on the client device 110.

The external data platform 120 represents one or more third-party services that maintain user-associated communication and scheduling data accessible over a network. In some embodiments, the external data platform 120 includes consumer or enterprise email systems (e.g., services that store and serve MIME-encoded messages and attachments), calendar systems (e.g., services that store and serve iCalendar event objects), or combinations thereof. The external data platform 120, which may be separately owned and managed from the online shared charter platform 140, may expose interfaces through which data objects associated with a particular user account can be discovered and retrieved.

In one or more embodiments, the external data platform 120 may expose programmatic interfaces for messages (email objects) and events (calendar objects). A message object may include headers (e.g., subject, sender or booking provider domain, message-id), one or more content parts (plain text, HTML, inline images), and attachments (e.g., PDF itineraries, image boarding passes, tickets). An event object may include an event identifier (e.g., UID), title, organizer domain, start/end timestamps, location fields (venue names or airport strings), description fields, guests, recurrence metadata, and optionally attachments. The external data platform 120 may provide these objects in native formats (e.g., RFC 5322 for email, iCalendar/ICS for events) and/or via provider-specific resource representations (e.g., JSON resources returned by a REST or Graph API).

The external data platform 120 can support multiple delivery and access modes. In a push mode, the platform 120 may emit change notifications to a subscriber endpoint when new or updated data objects are available; the notification payload may include stable resource identifiers and change tokens. In a pull mode, the platform 120 may serve authenticated search and retrieval requests with search parameters targeting message/event metadata (e.g., subject/title keywords, sender/organizer domains) and content fields (e.g., body/description text). In some embodiments, the platform 120 may support direct retrieval protocols (e.g., IMAP/POP for messages; CalDAV for events).

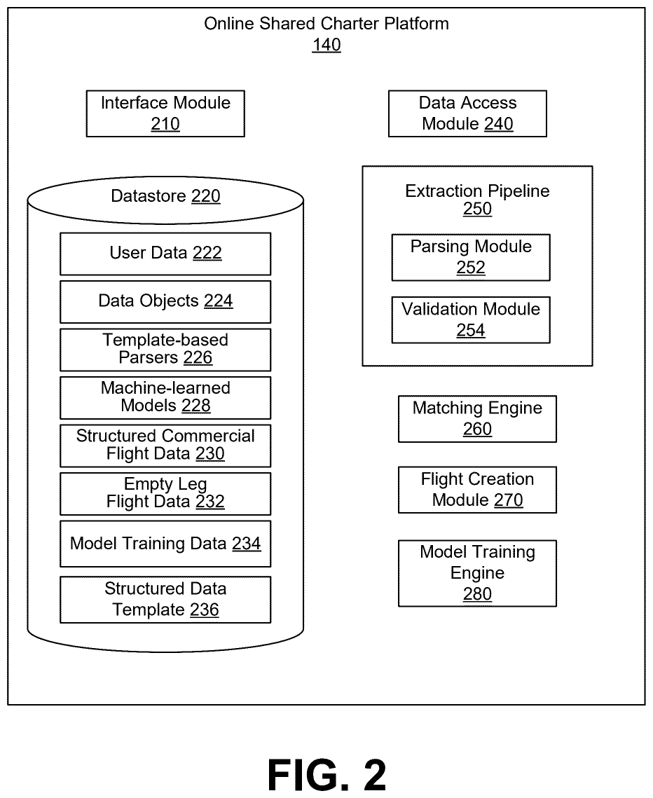

Although flight bookings are commonly received as email confirmations from airlines or travel agencies, related travel indicators may also appear as calendar events (e.g., event tickets, conference bookings, sports events such as a championship game). The external data platform 120 may provide both kinds of data objects to the platform 140: (i) messages containing structured or semi-structured booking content (e.g., HTML tables, confirmation numbers, route strings, departure/arrival times), and (ii) events whose metadata (e.g., title, location, start/end) can indicate travel plans even when an itinerary email is not present or not yet available. In operation, the external data platform 120 may function as the authoritative source of record for user-associated communication and scheduling artifacts (data objects). Detailed mechanism by which the platform 140 authenticates, subscribes, queries, and retrieves data from the external data platform 120 is described later in connection with FIG. 2.

The client device 110, the external data platform 120, and the online shared charter platform 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

In one or more embodiments, the online shared charter platform 140 may be a networked computing system that implements the end-to-end operations described herein, including (i) obtaining user-associated data objects from external data platforms 120, (ii) identifying commercial flight bookings (or event bookings) within those data objects, (iii) extracting structured commercial flight attributes using a template-first parser layer with validation and a machine-learned fallback layer guided by a structured data template, (iv) persisting a structured commercial flight dataset with normalization, (v) comparing the dataset to empty leg supply (including repeated and periodic comparisons to new empty leg supply as it becomes available) using geographic clustering and dual time-window constraints, and (vi) generating and transmitting operator-and user-facing notifications for flight opportunities. In one or more embodiments, platform 140 comprises one or more processors, memory, non-transitory storage, and network interfaces deployed on premises or in a cloud environment; exposes programmatic interfaces and user interfaces to client devices 110; maintains multi-tenant isolation, authorization state, and audit logs; and executes the foregoing functionality via constituent modules further described with reference to FIG. 2.

### Example Online Shared Charter Platform

FIG. 2 is a block diagram illustrating components of an example online shared charter platform 140, in accordance with one or more embodiments. As shown, platform 140 includes an interface module 210, a data access module 240, an extraction pipeline 250 having a parsing module 252 and a validation module 254, a matching engine 260, a flight creation module 270, and a model training engine 280. A Datastore 220 is operatively coupled to these modules and persists data and executable artifacts used by the platform's workflows. Although particular modules are depicted, alternative embodiments may combine, subdivide, or distribute functionality across different services or tiers than illustrated.

The Datastore 220 may store, by way of example and not limitation: user data 222 (e.g., user account data including account identifiers, authorization state, preferences); data objects 224 obtained from external data platforms (e.g., messages and events with provider identifiers and sync tokens); template-based parsers 226 (e.g., provider-specific rule sets and signatures); machine-learned models 228 (e.g., model parameters, prompts, and inference policies); structured commercial flight data 230 (parser-based or model-based normalized attributes, per-leg records, validation results); empty leg flight data 232 (operator supply records including route endpoints, departure windows, duration values, operational/commercial parameters); model training data 234 (e.g., pairs of data objects and validated structured attributes, evaluation metrics, and versioning metadata); and a structured data template 236 (e.g., schema definitions including required fields, nesting, and validator specifications).

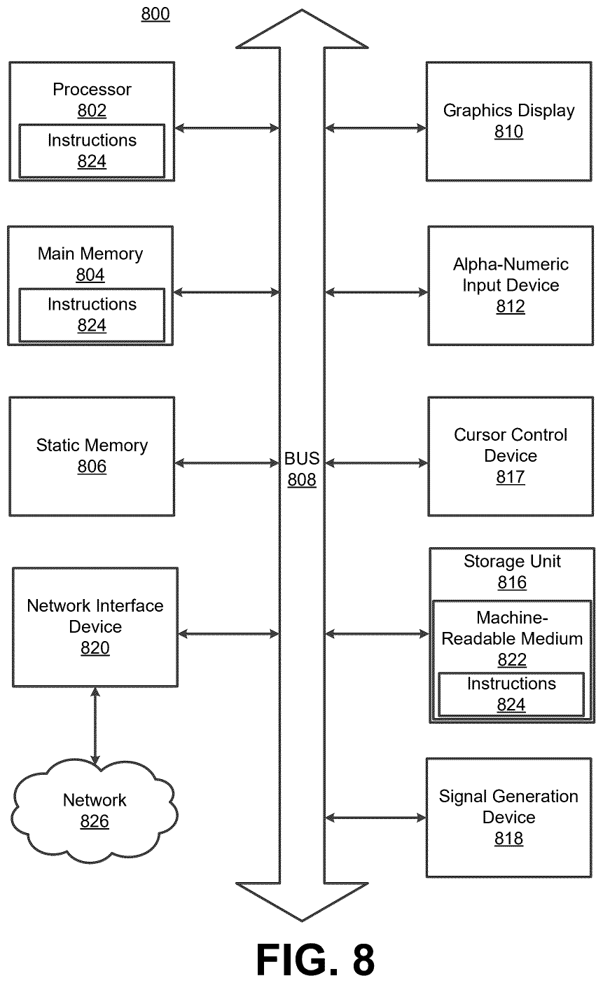

The components of FIG. 2 may be implemented in software, hardware, or any combination thereof. In various embodiments, each module is realized as program code stored on non-transitory media and executed by one or more processors, optionally deployed as distributed microservices communicating over message queues or RPC, and instrumented for retry and deduplication to ensure idempotent processing. In other embodiments, selected functionality may be accelerated or embodied in dedicated logic (e.g., FPGAs or ASICs). Each module of FIG. 2 may include all or part of the example computing architecture described with reference to FIG. 8.

The interface module 210 facilitates user interaction with the online shared charter platform 140 through a graphical user interface (GUI) presented on a client device 110. In one embodiment, the module 210 is a mobile application deployed by the platform and made available via distribution platforms such as the Apple App Store and Google Play Store. The mobile application executes on the client device and provides a native GUI for providing authorized access to email accounts or calendar accounts of the user on a third party platform, reviewing upcoming commercial flight bookings, review any matching private flights that are identified by the platform, book private flights, review and approve shared charter opportunities as a flight operator, share empty leg supply as the flight operator, and the like. In another embodiment, the interface module 210 may be implemented as a web-based application accessible through a browser on the client device, or as part of a software-as-a-service (SaaS) platform. In each case, the module communicates with backend components of the platform 140 using secure application programming interfaces (APIs), which may include RESTful endpoints, webhooks, or other mechanisms. The interface module 210 thus provides the front-end environment through which a user or flight operator interacts with the functionality enabled by the platform 140. Example GUIs generated by the interface module 210 are illustrated and described in connection with FIG. 5A-5F.

In one or more embodiments, the data access module 240 acquires data objects associated with a user account from one or more external data platforms. Data objects may include at least email messages and calendar events represented in provider-native formats (e.g., MIME/EML for messages, iCalendar/ICS for events) and/or provider resource representations (e.g., JSON returned by a REST or Graph API). The module 240 may store retrieved objects and associated provider metadata in the datastore 220 (e.g., data objects 224) and supply the objects to the extraction pipeline 250 for further processing.

The data access module 240 may retrieve the data object via authenticated access to an account of the user on the external data platform 120. The data access module 240 may establish an authenticated session to the external data platform using delegated authorization (e.g., OAuth2) scoped to an appropriate access level for the user's mailbox and/or calendar. The module may support linking multiple external accounts per user and record provider identifiers (e.g., tenant, mailbox, or calendar identifiers) so that subsequent object retrievals can be associated with the correct user data 222.

The data access module 240 may access the data objects by subscribing to an application programming interface (API) notification channel of the external data platform 120, that is, in a subscription (push) configuration, the external data platform can emit change notifications when new or updated data objects are available. The data access module 240 may register a subscription endpoint, completes provider verification or challenge/response, renew subscriptions before expiry, and verify signatures on incoming notifications. A notification payload typically includes a resource identifier and/or change token. Responsive to receipt of a notification, the module 240 may request the current version of the referenced object from the external data platform, record provider metadata (e.g., message-id or event-id, created/updated timestamps, labels/folders), and store a normalized envelope as data objects 224.

The data access module 240 may also access the data objects by transmitting one or more API calls to the external data platform 120, in such a query (pull) configuration, the data access module 240 may issue authenticated API calls to provider search endpoints. For messages, the module 240 may compose search parameters over metadata and content fields, such as subject keywords indicative of bookings, sender domains associated with airlines or travel agencies, and body text patterns matching itinerary or confirmation strings. For events, queries may target title, organizer domain, location, and description fields, optionally constrained to a time window.

In some embodiments, the data access module 240 may retrieve data via direct protocols. For email, the module may use IMAP or POP to search and fetch messages (e.g., IMAP SEARCH over SUBJECT, FROM, or date ranges; partial FETCH of MIME parts or BODYSTRUCTURE). For calendars, the module 240 may use CalDAV to issue calendar-query REPORTs over a time interval and fetch event resources, including recurrence expansions.

In addition to API-based acquisition, the platform 140 may provision an ingestion address to which a user forwards booking confirmations. The data access module 240 may receive such forwarded messages, associate them with the correct user account using envelope headers or per-user aliases in the user data 222, and store the resulting message objects as data objects 224. In some embodiments, manual entries supplied through the interface module 210 (e.g., user-entered itinerary details) may likewise be recorded as data objects 224 with an indication of their origin.

To avoid duplicate processing, the data access module 240 may maintain a record of processed identifiers and change tokens provided by the external data platforms and deduplicate objects arriving from multiple acquisition paths (e.g., the same message discovered by both push and pull) using stable identifiers (message-id/event-id) and, in some cases, using hashes. Upon detecting that an object already exists, the module 240 may update the stored record with any new provider metadata rather than creating a new entry.

In some embodiments, after storing an object 224, the data access module 240 may perform a detection step to determine whether the object is a candidate commercial flight booking (or, in some embodiments, a relevant event). Signals may include subject or title keywords, sender or organizer domains, body or description patterns, markup signatures, and attachment indicators (e.g., PDF itineraries). Objects meeting a threshold may be annotated and dispatched to the extraction pipeline 250 (parsing module 252 and validation module 254) for generation of structured commercial flight attributes.

In one or more embodiments, an extraction pipeline 250 receives data objects 224 (e.g., messages and events) selected by the data access module 240 as likely to represent a commercial flight booking and converts those data objects into structured commercial flight data 230. The pipeline 250 may be implemented as a two-stage extraction layer where a parser-based extraction serves as a primary extraction method and a trained machine-learned model provides fallback extraction for instances where the primary extraction method fails on validation. The pipeline 250 may operate over normalized inputs produced from provider payloads (e.g., decoded MIME parts, sanitized HTML, canonicalized text, parsed ICS properties) and emit per-leg records containing flight attributes suitable for downstream matching by the matching engine 260.

The parsing module 252 may maintain a registry of template-based parsers 226 that are provider-specific (e.g., airline or travel-agency formats) or class-specific (e.g., generic itinerary email, calendar event with travel descriptors). A parser may be selected for a given data object based on one or more selection signals, which can include: (i) sender/organizer domain matches; (ii) subject/title pattern matches; (iii) body/description text patterns; and (iv) markup signatures derived from the object's HTML or ICS structure. Selection may proceed by priority (e.g., exact domain match before pattern match) or by voting across signals, with a default parser available when no provider-specific template is detected.

The set of template-based parsers 226 may apply at least one of keyword matching, regular expression evaluation, or structured markup queries to extract a set of parser-based attributes from the data object. For example, the parsing module 252 may search email subject lines for predetermined keywords. The keywords may include names of popular airlines (e.g., “Alaska Airlines”, “United”), travel companies (e.g., “Expedia”), or words related to travel (e.g., “itinerary”, “flight”, and the like. The parsing module 252 may define specific templates or parsers 226 associated with the defined keywords. Based on the keywords identified in the search, the module 250 may utilize the associated predefined email parsers 226 to quickly and accurately extract flight details from the emails. The parsers 226 may use regular expressions to match strings or a combination of regular expressions and HTML queries to identify the flight details. The parsers 226 may be specific to the different email formats corresponding to itinerary emails from different airlines or travel companies. In one or more embodiments, the parsing module 252 may also employ the keyword searching and template or parser matching techniques to data objects 224 (e.g., iCal or Google Calendar integration for calendars) to determine more general travel plans or specific flight details of users and create the record of the member's commercial flight or travel plans for identifying alternative shared charter opportunities. For example, based on information indicating the user is going to be at a specific event in a different city or region, the system may automatically identify that the user will be travelling for that event and identify shared charter opportunities without a commercial flight booking to perform matching.

The parsing module 252 may determine whether there is a specific parser 226 that is appropriate for the email format of the email identified to include travel data 224 based on matching of subject keywords and strings within the email body. Responsive to the parsing module 252 determining there isn't a specific parser 226 to use for processing an email that is otherwise determined to contain details of an upcoming flight or itinerary, the parsing module 252 may utilize a default parser 226 to derive flight data from the email. The parsers 226 may extract itinerary details like date, time, origin airport, destination airport, layovers, duration, price, class of service, etc., from the identified emails 224, then normalize and store the information as a record in a database (e.g., structured data 230) of the member's commercial flight for identifying alternative shared charter opportunities.

Each template-based parser 226 may apply deterministic extraction rules to obtain flight attributes from the selected data object. The rules may include: lexical normalization and tokenization; keyword and n-gram matching against provider alias dictionaries; anchored regular-expression patterns with capture groups, back-references, and look-around assertions; and structured-markup traversal via Document Object Model navigation using XPath or CSS selectors with attribute filters and positional indices. The parser 226 may also compute derived values and segment multi-leg itineraries by recognizing leg headers, separators, or repeating table structures.

Parser output may be assembled into an intermediate object that enumerates, for each detected leg, a flight identifier (e.g., carrier code and number or provider-specific token), a set of departure attributes, and a set of arrival attributes. The intermediate object can further include passenger references, or booking confirmation identifiers. Field mappers may normalize tokens (e.g., trimming whitespace, canonicalizing flight number formats) and standardize temporal and location representations for later validation.

The validation module 254 may evaluate the parser output against a predefined schema (e.g., structured data template 236) that defines field names and types, required/optional status and cardinality, nested departure and arrival structures, and validator rules. Validator rules can include pattern checks for individual fields, numeric or temporal range checks, and cross-field consistency checks (for example, verifying the presence of both a departure and arrival structure for each leg, verifying ordering of times across a leg, and ensuring that a referenced code appears in the expected set for the selected provider template). The validation module 254 may record validation results and a completeness score in the datastore 220.

If the parser output satisfies the schema (e.g., the validation results indicate a pass or the completeness score is higher than a threshold), the validation module 254 may designate the result as a validated set of parser-based structured commercial flight attributes and forward the result to storage as structured commercial flight data 230. If the parser output fails one or more validator rules or fails to include required fields, the pipeline 250 may trigger a validated-failure condition and proceed to a machine-learned extraction path.

In the machine-learned path, a machine-learned model 228 receives the same data object 224 together with guidance including the structured data template 236. In some embodiments, the guidance may be provided as a schema specification or prompt that enumerates required fields, optional fields, and nesting, together with examples of acceptable field encodings. The model 228 may generate a candidate set of model-based structured commercial flight attributes. Generation may use constrained decoding techniques to restrict outputs to schema-compatible structures.

The validation module 254 may apply the same validator rules to the model-based attributes. When a nonconforming field is detected, the module 254 may execute a localized repair step (e.g., re-formatting a field, substituting a mapped token) or request targeted regeneration of the specific field or leg from the machine-learned model 228 using the structured data template 236 as context. The result of this pass may be a schema-conforming object annotated as model-based.

Using the two-step process outlined above, the extraction pipeline 250 may write the structured commercial flight data 230 to the datastore 220 with information indicating whether the data is parser-based or model-based, the selected parser identity (if any), validation outcomes, and references to the source data object 224. Where the input represents a multi-leg itinerary, the pipeline may emit separate leg records linked by a common booking identifier. Where the input represents a connecting flight itinerary, the pipeline may emit one or more leg records linking the origin to the final destination. The pipeline 250 may also compute auxiliary attributes for downstream use, such as per-leg durations or leg ordering indices.

In some embodiments, the parsing module 252 and validation module 254 expose instrumentation that records selection signals, rule matches, validator failures, and model regeneration events. These records may be aggregated as model training data 234 and later used by a model training engine 280 to improve provider-specific parsers or to fine-tune the machine-learned model 228 using pairs of data objects 224 and validated structured outputs 230.

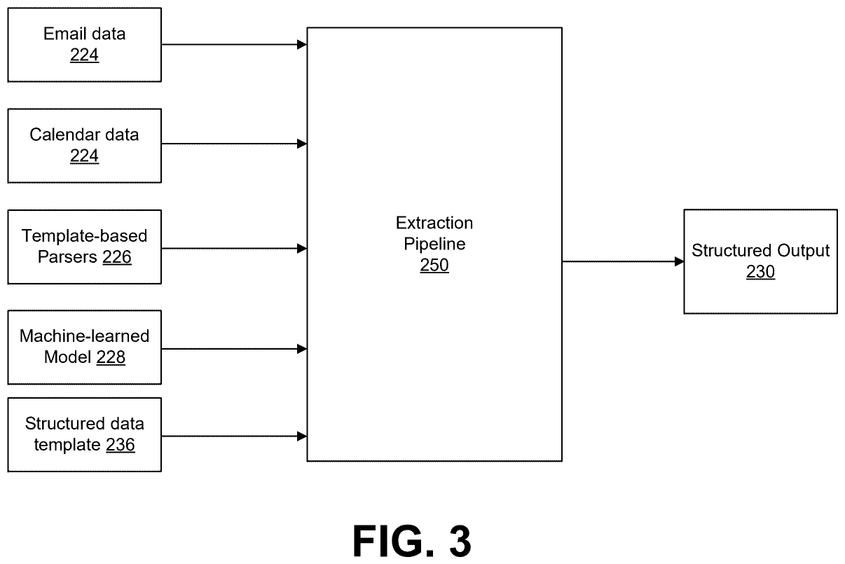

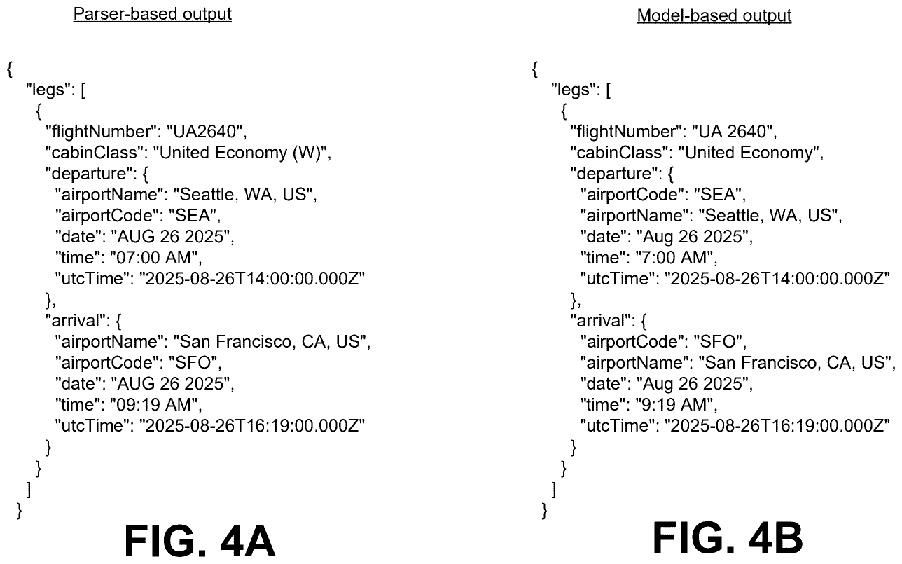

Operation of the extraction pipeline 250 and generation of structured data 230 is explained in further detail below in connection with FIGS. 3, 4A, and 4B. FIG. 3 is a block diagram illustrating generation of structured commercial flight data 230 by the two-stage extraction pipeline 250 of the online shared charter platform 140. FIGS. 4A-4B show examples of structured commercial flight data 230 generated respectively by a template-based parser 226 and a machine-learned model 228 of the online shared charter platform 140.

FIG. 3 shows that the extraction pipeline 250 may receive multiple inputs and produce a structured commercial flight data output 230. Inputs may include email-derived data objects 224 or calendar-derived data objects 224 that have been selected (identified) as likely to contain booking information, a registry or set of predefined template-based parsers 226, one or more machine-learned models 228, and a structured data template 236 that specifies a target schema for the output 230. The pipeline 250 may normalize provider payloads (e.g., decodes MIME parts, sanitizes HTML, canonicalizes text, and parses ICS properties) and execute a two-stage extraction. First, a parser selected from the registry or set of parsers 226 may apply deterministic rules to extract per-leg attributes. The parser output may then be evaluated by a validation module 254 against the template 236. If the parser output satisfies required fields and consistency checks, the pipeline may emit the result as structured output 230. If validation fails, the pipeline 250 may execute a machine-learned path in which the model 228 is conditioned by the template 236 to generate a candidate structured result that may be re-validated and, when appropriate, locally repaired before emission as the structured output 230.

The structured data template 236 may define a machine-readable schema for the structured output 230, including field names and types, required versus optional fields and cardinality, nested per-leg structures for departure and arrival, airport code format, and timestamp format. Validation by the validation module 254 may enforce field-level rules (e.g., pattern checks, numeric and temporal range checks) and cross-field consistency (e.g., that each leg includes both a departure and an arrival and that temporal ordering across a leg is coherent). In some embodiments, validation and normalization may further standardize attribute values to platform-wide conventions, including: (i) mapping airport indicators to a canonical dictionary of three-letter IATA codes, with name-to-code resolution when only an airport name is present; (ii) resolving local date/time strings to a standardized timestamp format (e.g., ISO-8601 expressed in UTC) using an airport-to-timezone map with daylight-saving rules; (iii) canonicalizing flight identifiers to a uniform representation (e.g., carrier designator followed by a zero-padded numeric flight number, without embedded whitespace); (iv) mapping cabin-class labels from provider-specific aliases to an internal enumeration; (v) computing per-leg duration from normalized timestamps; and (vi) ordering multi-leg itineraries and verifying connection feasibility based on derived connection intervals. When a parser-produced object is incomplete or non-conforming, the same template 236 may be used to guide the model 228 toward schema-conformant output (e.g., constrained decoding to the schema, targeted regeneration of specific fields), after which the validator 254 may re-apply the standardization steps so that both parser-based and model-based outputs share identical formats.

FIG. 4A shows an example of a parser-based structured output 230 generated by a template-based parser 226. The output includes a top-level legs array; each leg containing a flightNumber, a cabinClass, and nested departure and arrival objects. The nested objects include an airport identifier normalized to an IATA code and time fields normalized to the standardized timestamp format (e.g., a UTC ISO-8601 value that includes a local time zone designator). In the example of FIG. 4A, the parser-based structured output 230 includes a single leg with a commercial carrier flight number and departure/arrival attributes for specific airports, each with normalized timestamps. The example of FIG. 4A illustrates a set of parser-based structured commercial flight attributes extracted by a corresponding parser 226, where the attribute fields and values have been validated by the module 254 to produce a validated set of parser-based structured commercial flight attributes that are stored as the structured output 230 in the data store 220.

FIG. 4B shows an example of a model-based structured output 230 generated by the machine-learned model 228 when the parser path did not produce a validated result. The model's output conforms to the same schema as in FIG. 4A: a legs array with per-leg objects including flightNumber, cabinClass, and nested departure/arrival structures with normalized airport and time fields. Although surface tokens (e.g., spacing in a flight number or capitalization in a cabin-class label) may differ from the parser-based example, the result satisfies the template-driven validators and normalization rules and is accepted as structured commercial flight data 230. Thus, the example of FIG. 4B illustrates a set of model-based structured commercial flight attributes output by the machine-learned model 228 from the data object 224, where the attribute fields and values have been validated by the module 254 to produce a validated set of model-based structured commercial flight attributes that are stored as the structured output 230 in the data store 220.

In some embodiments, both parser-based and model-based outputs may capture additional attributes and metadata, such as booking confirmation identifiers, passenger references when present, derived per-leg durations, a completeness score, and provenance fields including the selected parser identity or model configuration and a reference to the source data object 224. Multi-leg itineraries may be represented by multiple leg entries within the legs array and linked by a common booking context. The structured output 230 produced as shown in FIG. 3-4B may be written to the datastore 220 and thereby made available to downstream components for matching and opportunity generation.

Returning to FIG. 2, the matching engine 260 may analyze the structured commercial flight data 230 and the empty-leg flight data 232 to identify candidate opportunities for private flight utilization. Empty-leg supply may be created by operators via an interface (e.g., through interface module 210) or ingested from operator systems via APIs. The empty leg data 232 may include route endpoints, a departure start time and end time defining a departure window, a duration value, operational flags, and commercial parameters (e.g., a minimum revenue threshold) stored in the datastore 220 alongside status and audit metadata. In some instances the supply record may omit an arrival time; the arrival interval may be derived from the departure window and duration during matching.

The matching engine 260 may implement a constraint-aware comparison between (i) a member's structured commercial itinerary (per-leg origin/destination and normalized timestamps stored in dataset 230) and (ii) an empty-leg specification (origin/destination, departure window, and duration stored as empty leg flight data 232), by applying a geographic clustering of airports into metropolitan areas, and/or dual time-window constraints comprising a departure time window and an arrival time window. That is, in some embodiments, the engine 260 may resolve each endpoint to a geographic cluster (e.g., a metropolitan-area grouping of proximate airports) and treats any airport in the same cluster as interchangeable for purposes of routing compatibility. Cluster definitions may be configurable and curated, and the engine 260 may require that both the commercial origin and commercial destination map to the clusters corresponding to the empty leg's origin and destination, respectively. For example, the engine 260 may define a “Los Angeles” geographic cluster as {LAX, VNY, BUR, LGB, SNA} and a “New York” geographic cluster as {JFK, EWR, TEB, LGA, HPN}. A member's commercial itinerary 230 may indicate an origin of LAX and a destination of EWR (LAX→EWR), while an available empty-leg supply record 232 may specify VNY to TEB with a departure window of 2:00-5:00 PM (Los Angeles time) and a recorded duration of 5 hours. In this example, the engine 260 may map LAX and VNY to the Los Angeles cluster and EWR and TEB to the New York cluster and determine that the origin cluster pair (Los Angeles) and destination cluster pair (New York) are compatible, and thus treats the empty leg (VNY→TEB) as a route match for the commercial booking (LAX→EWR).

In some embodiments, the engine 260 may also evaluate temporal compatibility using dual time-window constraints. For a given empty leg, the engine 260 may first evaluate a departure window defined by the supply record (e.g., [start, end]) and derive a corresponding arrival interval by applying the recorded duration to candidate departure times. The engine 260 may then construct commercial-flight comparison windows relative to the empty leg's windows (e.g., a window surrounding the empty leg's departure, and a window surrounding the derived arrival interval) and deem a member leg temporally compatible when the commercial departure time falls within the configured departure comparison window and/or the commercial arrival time falls within the configured arrival comparison window. Window bounds may be tunable (e.g., configured based on member user preferences, private flight operator preferences) and may be expressed in local or normalized time. For example, a comparison window may span portions of the preceding and following day relative to the empty leg's window. For example, consider the VNY to TEB empty leg with a departure window of 2:00-5:00 PM (Los Angeles time) and a recorded duration of 5 hours. From these values, the engine 260 may derive an arrival interval of 10:00 PM-1:00 AM (New York time). The engine 260 may then define commercial-flight comparison windows (depending on member user and/or flight operator configurable settings) relative to these bounds. For example, for a particular member user in this instance, a departure comparison window may be 1:00-8:00 PM (Los Angeles time) and an arrival comparison window may be 9:00 PM-2: 00 AM (New York time). Thus, a member itinerary that departs 3:00 PM (Los Angeles) and arrives 11:00 PM (New York) falls within both comparison windows and may be deemed temporally compatible by the matching engine 260. As another example, a member itinerary that departs 12:45 PM (Los Angeles) (outside the departure comparison window) but arrives 10:15 PM (New York) (inside the arrival comparison window) may still be deemed temporally compatible under an “and/or” rule by the matching engine 260. However, a member itinerary that departs 10:30 PM (Los Angeles) and arrives 4:30 AM (New York) is outside both comparison windows and may not be deemed temporally compatible by the matching engine 260.

The matching engine 260 may identify matches by filtering the structured commercial flight dataset 230 to members whose legs satisfy both the geographic-cluster mapping and the dual time-window constraints relative to an empty leg. Entries flagged as ignored by the member, already matched to an opportunity, or outside configured thresholds may be excluded. When a single member leg satisfies the constraints for a particular empty leg, the engine 260 may adopt that member's commercial departure time as the proposed departure time for the opportunity, provided it lies within the empty leg's departure window. When multiple member legs satisfy the constraints, the engine 260 may compute a proposed departure time as a central tendency (e.g., a median of the matched commercial departure times), then round the proposal to a nearest operational interval (e.g., 30 minutes) while constraining the result to the empty leg's departure window. A corresponding provisional arrival time may be computed by adding the empty leg's duration to the proposed departure time; both values may be persisted into the opportunity record.

Upon identifying a match, the engine 260 may generate a flight-opportunity record that references the empty-leg supply record item 232 and the matched member legs 230, and include the proposed schedule (departure time and derived arrival time), the cluster pair applied, time-window bounds, and a status with an expiration or confirmation deadline. The engine 260 may then evaluate operator-configurable constraints (e.g., a minimum revenue threshold or other operational criteria). Responsive to determining that such constraints are satisfied, the platform 140 may orchestrate transmission of user-facing notifications (e.g., client device push notifications, SMS messages, email) to the matched members and schedule reminder notifications. In some embodiments, the platform may also transmit an operator-facing notification with a resource identifier for the flight-opportunity record to solicit approval; and responsive to approval from the operator, the matching engine 260 may advance the opportunity by surfacing it to the matching member users.

Configuration parameters, such as cluster definitions, time-window offsets, rounding intervals, exclusion rules, and operator constraints, may be stored in the datastore 220 and may be adjustable without redeploying the engine 260. In some embodiments, preference signals (e.g., historical acceptance patterns) may be incorporated to prioritize opportunities for particular members or routes, while preserving the mandatory geographic-cluster and temporal-window checks. The matching engine 260 thus provides a deterministic, parameterized matching workflow that supports the operations recited herein and enables automated opportunity generation from normalized commercial itinerary data and variably specified empty-leg supply.

In one or more embodiments, the flight creation module 270 orchestrates conversion of a matched opportunity into an operational private flight. The module 270 may interface with the matching engine 260 to receive a reference to a flight-opportunity record (e.g., including identifiers for the empty leg supply item 232 and the matched member legs from the structured commercial flight data 230, together with a proposed departure time and a derived arrival time). The module 270 may maintain state for the opportunity (e.g., proposed, pending-operator, pending-member, confirming, confirmed, or expired) and expose programmatic and user-facing flows through the interface module 210 to advance the state.

In some embodiments, the module 270 may present the opportunity to matched members via the interface module 210, including route, proposed schedule, aircraft or cabin attributes (if available), share availability, and price. The module 270 may collect member confirmations and payment authorizations through an integrated payment flow (e.g., interaction with a payment service provider), records a per-member commitment (e.g., hold amount or preauthorization), and updates an opportunity ledger that tracks the number of committed shares and the aggregate committed revenue. Configuration may permit a soft-commit phase in which authorizations are placed but not captured until operator approval or threshold satisfaction.

The module 270 may evaluate operator-configurable constraints associated with the opportunity, such as a minimum revenue threshold, a maximum number of shares, latest permissible departure time within the departure window, and policy flags (e.g., pets allowed, cabin attendant, baggage policies). When constraints are satisfied by member commitments, the module 270 may automatically transition the opportunity to “pending-operator” or, if permitted by configuration, proceed directly to “confirming.” In parallel, the module 270 may transmit an operator-facing notification (e.g., through an operator console or API callback) that includes a resource identifier for the flight-opportunity record, the proposed schedule, committed headcount and revenue, and a summary of operational attributes.

Responsive to operator input, the module 270 may process an approval or rejection.

Approval may include edits to operational parameters (e.g., selecting a specific aircraft tail, assigning origin/destination FBOs, adjusting the proposed departure within the window). If approved, the module 270 may create a flight record in the datastore 220 that links the opportunity to the selected empty leg supply record 232 and to the confirmed member bookings from 230, and sets the flight status to confirmed. Creation may trigger capture of previously authorized payments, allocation of flight shares to members, issuance of member itineraries, and generation of an initial passenger manifest.

When operator approval is required but not received before an expiration or confirmation deadline, the module 270 may automatically expire the opportunity, release any holds or authorizations, and notify members. In other embodiments, an operator override policy may allow the operator to approve and create the flight notwithstanding one or more unmet constraints (e.g., minimum revenue), in which case the module 270 may record the override decision and proceeds with flight creation as described.

After flight creation, the module 270 may coordinate downstream notifications and artifacts. For members, the module 270 may orchestrate interactivity with interface module 210 to transmit user-facing notifications (e.g., push, email, SMS) that include the confirmed schedule, departure and arrival locations (e.g., FBO details, if available), check-in instructions, and any required information collection (e.g., passenger name, date of birth, identification details). For operators, the module 270 may provide an updated operator view including the confirmed flight record, the passenger manifest, contact information, and any operational notes required for dispatch.

In some embodiments, the module 270 may support settlement and adjustment flows. If a member cancels before a configured cutoff, the module 270 may release or refund according to policy, decrement committed revenue, and attempt to backfill the flight share by notifying waitlisted members. If the committed revenue falls below an operator threshold after cancellation, the module 270 may place the flight back into a “pending-operator” or “at-risk” status and solicit an operator decision to proceed, adjust pricing, or cancel.

The module 270 may expose APIs to synchronize the created flight to operator systems (e.g., schedule ingestion endpoints) and to receive updates (e.g., aircraft assignment changes). Updates may be applied to the flight record and propagated to member notifications as needed. In some embodiments, the module 270 may also record audit metadata for each transition (e.g., approval timestamp, approver identity, payment capture result identifiers, notification delivery outcomes) to support reconciliation and regulatory compliance.

The functionality of the online shared charter platform 140 enables a closed-loop workflow from opportunity surfacing to flight creation: member intent and payments are collected against a proposed schedule; operator constraints are evaluated and, upon approval, a concrete flight is instantiated and bound to committed members; and both operator-and user-facing notifications are issued to complete confirmation. The platform 140 thus supports automated creation of private flights from matched opportunities while allowing operator control and configurable commercial policies.

In one or more embodiments, the model training engine 280 prepares, curates, and uses model training data 234 to train or fine-tune the machine-learned model(s) 228 for extraction of structured commercial flight attributes from data objects 224. The model training data 234 may include, inter alia: (i) pairs of input data objects 224 (e.g., full raw email payloads with headers and MIME parts; HTML bodies; text-only bodies; attachments such as PDFs or images; calendar event objects) and (ii) corresponding validated structured outputs 230 produced by the extraction pipeline 250 (e.g., parser-based outputs that have passed validation 254 and, in some cases, human-verified corrections).

The training engine 280 may materialize multiple views of each item, e.g., raw RFC-5322, HTML-only, text-only, attachment-only, or ICS, so that specialized models can be trained for different content modalities. Structured outputs 230 used as supervision may originate from validated parser results, validated model results, or human-edited ground truth; when conflicts are present, the engine 280 may record an adjudicated target after human review or secondary model arbitration.

In some embodiments, supervised training may be formulated at the schema level defined by the structured data template 236. For each training pair, the engine 280 may provide the data object 224 (and, optionally, schema descriptors) as input and may update model parameters to minimize a composite loss between the model-predicted structured attributes and the validated target 230. The composite loss may comprise per-field token or span losses, penalties for missing required fields, penalties for invalid cardinality, and penalties for cross-field inconsistencies detected by validator rules (e.g., per-leg departure/arrival coherence). This objective encourages both extraction accuracy and conformance to the schema. In some implementations, the engine 280 may enable constrained decoding against the template 236 during training and/or inference, and incorporates targeted regeneration when a predicted field violates a validator rule.

The model training engine 280 may support multiple model families and sizes. For example, smaller models may be optimized for low-latency, high-throughput inference (co-hosted with platform services), while larger models may be allocated for offline verification, retraining, or arbitration. A multi-model strategy may be employed in which separate models are trained for distinct input regimes, e.g., (i) text-only bodies, (ii) HTML content, (iii) attachment-centric inputs such as PDFs or images (optionally with OCR pre-processing), and (iv) full raw payloads including headers and MIME structure.

Continuous learning workflows may be enabled. The engine 280 may harvest error sets (cases where inference disagrees with validator checks or human review), prioritize them for labeling, and add the verified corrections to model training data 234 for subsequent runs. Likewise, newly validated parser outputs (e.g., after parser updates or new templates) may be incorporated into the corpus, strengthening coverage for known providers while providing drift resistance as formats evolve. The engine may schedule periodic retraining/fine-tuning jobs, with change detection based on rolling metrics (e.g., degradation in precision/recall on specific fields or providers).

In operation, the model training engine 280 enables the platform to (i) leverage validated parser outputs as high-quality supervision targets for training and fine-tuning, (ii) continuously absorb corrected or difficult cases into the corpus, and (iii) field specialized models 228 that improve extraction accuracy and schema adherence across heterogeneous formats. As a result, model 228 performance improves over time while remaining aligned with the structured data template 236 and validator 254 rules, thereby reinforcing the two-stage extraction pipeline 250.

### Example Graphical User Interfaces

FIG. 5A-5F illustrate example user-interface presentations generated by the interface module 210 that are driven by data produced by the data access module 240, the extraction pipeline 250, the matching engine 260, and the flight creation module 270. The screens are rendered by a native or web client on a client device 110 and are populated from records persisted in the datastore 220 (e.g., structured commercial flight data 230, empty-leg flight data 232, and flight-opportunity records). FIG. 5A shows a home view following ingestion and extraction. In this example, the interface presents a “Your Upcoming Commercial Flights” section listing normalized itinerary legs from structured commercial flight data 230 associated with the member (e.g., PWM→MIA on a given date/time and, later, MIA→LAX), each rendered with origin/destination identifiers, local times, and an action control such as “Ignore this flight.” Invoking the ignore control sets a flag on the corresponding record in dataset 230, which the matching engine 260 consults to exclude the leg from future matching passes. The home view is updated incrementally as the data access module 240 ingests new data objects 224 and the extraction pipeline 250 outputs additional structured entries.

FIG. 5B shows an OS-level push notification emitted when the matching engine 260 identifies a private-flight opportunity satisfying the configured geographic-cluster and time-window constraints for a member's normalized itinerary. The notification payload may include a deep-link token referencing the flight-opportunity record stored by the platform 140. Activating the notification may open the client application to the opportunity detail, as illustrated next.

FIG. 5C presents the opportunity detail view that juxtaposes the private shared-charter candidate against the member's commercial flight for context. The upper panel displays the private leg (e.g., KPWM→KOPF, non-stop, with departure and arrival timestamps), while a comparison panel underneath reproduces the correlated commercial leg (e.g., PWM→MIA).

Although the arrival airports differ, both KOPF and MIA belong to the same metropolitan-area cluster (Miami), and the interface renders an annotation (e.g., “Compare to your commercial flight . . .”) to indicate cluster-level compatibility supplied by the matching engine 260. In this example, the private flight arrives earlier (e.g., 01:54 PM versus 05:00 PM), a computed benefit derived from normalized timestamps. A pricing control exposes both a per-share fare (e.g., for one traveler) and a full-plane price; user interaction with these controls posts a booking intent to the flight creation module 270.

FIG. 5D shows a pricing and detail confirmation view for the private shared-charter opportunity. The view reiterates the normalized route, scheduled times (derived from the proposed departure and duration produced by the matching engine 260), airport names and FBO information when available, and the selectable quantity of travelers constrained by current flight share availability. Price fields are computed server-side based on operator parameters and are bound to the UI for transparent recalculation as the traveler count changes. Selecting “Continue” advances the state of the referenced flight-opportunity record and transitions to payment and identity confirmation.

FIG. 5E shows a member details and payment pane. Member profile attributes (e.g., name, date of birth, contact) are sourced from user data 222 and are editable in place; edits are persisted back to 222 and associated with the pending booking. The payment selector exposes instrument options supported by an integrated processor (e.g., credit/debit card entry or wallet payment). On submission, the client generates a payment authorization request, which the flight creation module 270 records as a per-member commitment tied to the opportunity. When policy requires operator approval or a revenue threshold, the authorization may be held pending final confirmation; when auto-confirmation is permitted, the authorization may be captured and the flight record instantiated as described above.

FIG. 5F shows the home view updated after the opportunity has been surfaced and retained in the member's session. A “Your Matched Flights” section is rendered to elevate the opportunity, with a banner (e.g., “Book now before it's gone!”) when the opportunity is still pending and actionable, or a confirmation badge when the private flight has been created. The matched-flight card presents the normalized private route and schedule (e.g., KPWM→KOPF, 11:00 AM-01:54 PM) and links back to the opportunity or confirmed flight record. Below, the member's commercial flights remain listed from 230, optionally with controls to suppress further matching for a given leg. This view allows the member to re-enter the booking flow, view private flight booking status, view confirmations, or manage participation, while the platform updates the presentation in near-real-time in response to state transitions issued by the matching engine 260 and flight creation module 270.

### Example Methods

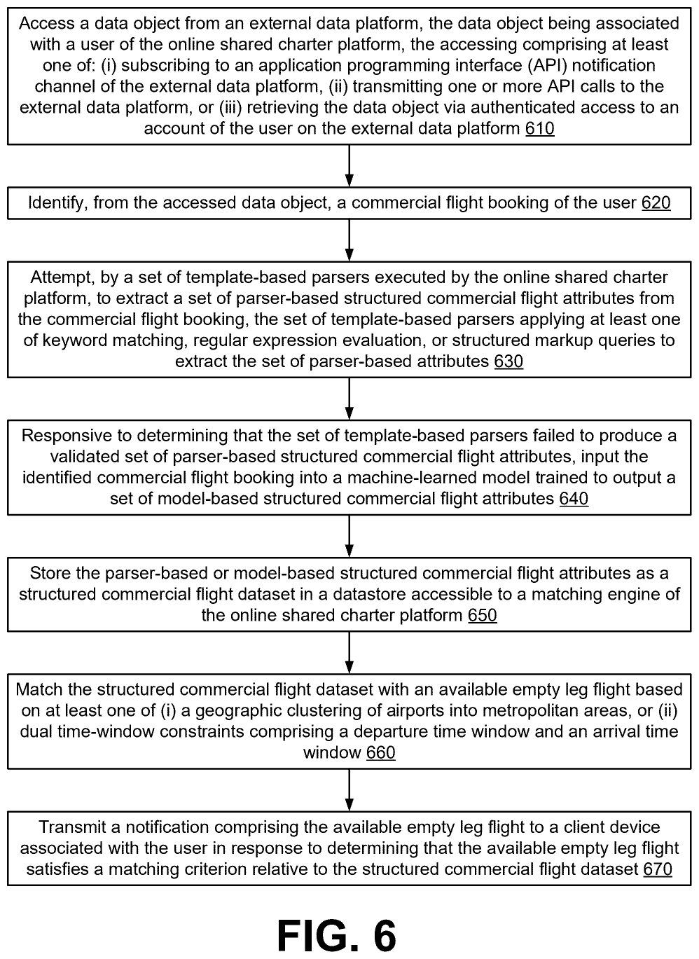

FIG. 6 illustrates a flowchart of an example method 600 performed by the online shared charter platform 140 to automatically extract and utilize commercial flight information and surface empty-leg opportunities. Although shown as a series of discrete steps, method 600 may be implemented with steps executed in a different order, in parallel, and/or omitted or supplemented in particular embodiments. The operations of method 600 may be executed automatically by platform 140 without human intervention.

At step 610, the data access module 240 may access a data object 224 associated with a user from an external data platform 120. Access may take any of the following forms: (i) subscribing to a provider API notification channel so that change events (e.g., “new message” or “new calendar event”) are delivered to a platform endpoint together with resource identifiers; (ii) issuing authenticated API calls (pull queries) that search provider indexes using metadata/content constraints such as subject/title keywords, sender/organizer domains, and body/description text patterns indicative of bookings; or (iii) authenticated retrieval using user-granted credentials or delegated tokens (e.g., IMAP/POP for messages; CalDAV for events). The module 240 may write a normalized envelope of the retrieved object (headers/metadata, MIME/HTML/ICS content, attachments, and provider identifiers) to data objects 224.

At step 620, the platform may identify the accessed data object to determine whether it represents a commercial flight booking. In some embodiments, a lightweight detector executed by the data access module 240 may evaluate subject/title terms, sender/organizer domains associated with airlines or travel services, body/description patterns, markup signatures (e.g., HTML table structures), and/or attachment indicators (e.g., PDFs with confirmation strings). Objects that meet a threshold are marked as booking candidates and dispatched to the extraction pipeline 250.

At step 630, the parsing module 252 may select a template-based parser from the registry 226 and apply deterministic extraction rules to obtain a parser-based set of structured commercial flight attributes. Selection signals may include sender/organizer domain matches, subject/title patterns, body/description patterns, and markup signatures derived from HTML or ICS. The selected parser may execute lexical normalization and tokenization; keyword and n-gram matching; anchored regular-expression capture with look-around assertions; and structured-markup queries (e.g., DOM traversal via XPath/CSS selectors) to extract per-leg attributes such as flight identifier, departure attributes, and arrival attributes. The resulting candidate may be evaluated by the validation module 254 against a structured data template 236 that defines field names and types, required/optional status and cardinality, and nested per-leg structures.

At step 640, when the validation module 254 determines that the parser output is not a validated set (e.g., one or more required fields missing or failing schema checks), the pipeline 250 may input the same identified commercial booking 224 into a machine-learned model 228. The model 228 may be guided by the structured data template 236 (e.g., supplied as schema descriptors and/or exemplars) and generate a model-based set of structured commercial flight attributes. In some embodiments, constrained decoding is employed to bias outputs to the schema, and the validator may perform localized repair or targeted regeneration for any nonconforming fields. The output of this path may be re-validated against the template 236.

At step 650, the platform 140 may store, in the datastore 220, the resulting structured commercial flight dataset 230 indicating whether the entry is parser-based or model-based, together with metadata suitable for downstream processing. Normalization may include standardizing airport identifiers to a canonical dictionary and normalizing timestamps to a standardized format, thereby enabling consistent comparison semantics in later stages.

At step 660, the matching engine 260 may analyze the structured commercial flight dataset 230 against empty-leg flight data 232. Route compatibility may be evaluated by mapping commercial and empty-leg endpoints to geographic clusters (e.g., metropolitan-area groupings of proximate airports) and requiring that origin and destination cluster pairs correspond. Temporal compatibility may be evaluated using dual time-window constraints: the engine 260 may consider both an empty-leg departure window and a derived arrival interval (computed from the departure window and a recorded duration) and compare these against commercial departure/arrival times using configurable comparison windows. Candidate legs that satisfy the cluster mapping and the dual time-window checks may be retained as matches; entries 230 flagged as ignored or already matched may be excluded. When multiple commercial legs 230 match a single empty leg, a proposed departure time may be computed (e.g., a median of matched commercial departures) and rounded to an operational interval within the departure window, with a corresponding arrival time derived from duration.

At step 670, responsive to determining that an available empty leg satisfies the matching criterion relative to the structured dataset 230, the platform 140 may transmit a notification to a client device 110 associated with the user via the interface module 210. The notification (e.g., FIG. 5B) may reference the opportunity (e.g., via a deep link to a flight-opportunity record) and may include route and schedule details (e.g., FIG. 5C) derived by the matching engine 260. Subsequent user interaction may invoke flows of the flight creation module 270 (e.g., review, commitment, payment, and operator approval), as described elsewhere.

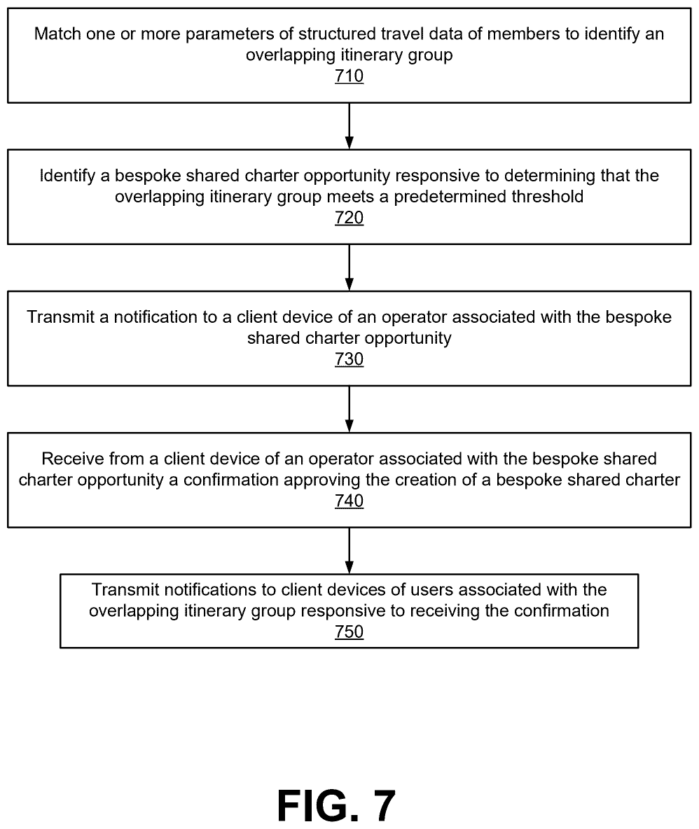

FIG. 7 is a flowchart illustrating an example method 700 for automatically creating bespoke shared charters in the absence of a preexisting empty-leg record, in accordance with one or more embodiments. Although shown as a sequence of steps, method 700 may be reordered, combined, or omitted in various implementations and may be performed automatically by the online shared-charter platform 140.

The matching engine 260 may match one or more parameters of members'structured travel data to identify an overlapping itinerary group (step 710). Using normalized records from structured commercial flight data 230 (and, in some embodiments, structured event data derived from calendar objects), the engine 260 may evaluate origin/destination (mapped to geographic clusters), departure and/or arrival windows, travel dates, and optional pricing or layover preferences. Members whose itineraries satisfy the cluster and temporal-window criteria for a common route/timeframe may be grouped together; cohort metrics such as group size, aggregate willingness-to-pay proxies, and candidate departure-time distributions may be computed.

The matching engine 260 may identify a bespoke shared-charter opportunity when the overlapping itinerary group satisfies one or more predetermined thresholds (step 720). Thresholds, curated by operators and/or configured by the platform, may include minimum group size, realizable revenue, serviceable origin/destination clusters, aircraft class/share availability, and permissible departure windows. When exceeded, the engine 260 may persist an opportunity record in datastore 220 containing a proposed cluster pair, candidate schedule (e.g., proposed departure within the cohort distribution and a derived arrival based on duration), and indicative commercial parameters (per-share and whole-aircraft pricing).

The flight creation module 270 may transmit an operator-facing notification for the bespoke opportunity (step 730). Suitable operators may be determined based on declared service areas, available aircraft classes, and current availability windows. The notification may reference the opportunity record and present cohort details (headcount, proposed schedule bounds, cluster pair, estimated revenue, operational notes). In some embodiments, multiple operators may be notified and an operator selection policy (e.g., first acceptance, ranked preferences, or bid/offer workflow) may be applied.

The platform 140 may receive an operator confirmation approving creation of the bespoke shared charter (step 740). The approval may include edits to operational parameters (aircraft tail assignment, FBO selections, or an adjustment to the proposed departure within the permissible window). Responsive to approval, the flight creation module 270 may instantiate a flight record linked to the opportunity and the operator, set any confirmation deadline, and transition a state to confirmed (or pending member completion if payments/confirmations are required).

The flight creation module 270 may transmit member notifications to client devices of users in the overlapping itinerary group (step 750). Notifications may deep-link to the booking flow (e.g., FIG. 5C-5E) where members review normalized flight details and pricing, confirm participation, and, if required, authorize payment. As confirmations are collected, the module may update the opportunity ledger (committed shares and revenue) and reflects status back to the operator console; if thresholds are unmet by a deadline, the module may expire the opportunity or solicit operator direction (proceed, adjust pricing, or cancel).

In some implementations, before operator notification, the matching engine 260 may solicit member intent by transmitting indicative offers to the overlapping group (e.g., price/time-window proposals) and aggregate responses to refine the cohort's size and schedule; the refined opportunity may then be presented to operators. Conversely, after operator confirmation, the platform may surface alternative bespoke options (e.g., different aircraft classes or nearby origin FBOs) under the same opportunity umbrella.

Method 700 thus leverages the same normalized schema-conformant travel data 230 and clustering/time-window machinery described elsewhere to generate supply from demand: when datastore 232 lacks a matching empty leg, the platform 140 may detect overlapping member itineraries, constructs a bespoke shared-charter opportunity, coordinate operator approval via module 270, and notify relevant members for booking via interface module 210.

### Example Computer System

FIG. 8 is a block diagram illustrating components of an example machine for reading and executing instructions from a non-transitory machine-readable medium, in accordance with one or more embodiments. Specifically, FIG. 8 shows a diagrammatic representation of one or more of the online shared charter platform 140, the client devices 110, the machine for performing the process 600 of FIG. 6, and the machine for performing the process 700 of FIG. 7 in the example form of a computer system 800.

The computer system 800 can be used to execute instructions 824 (e.g., program code or software) for causing the machine to perform any one or more of the methodologies (or processes) or modules described herein. In alternative embodiments, the machine operates as a standalone device or a connected (e.g., networked) device that connects to other machines. In a networked deployment, the machine may operate in the capacity of a server machine or a client machine in a client-server network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 824 (sequential or otherwise) that specify actions to be taken by that machine. Further, while only a single machine is illustrated, the term “machine” shall also be taken to include any collection of machines that individually or jointly execute instructions 824 to perform any one or more of the methodologies discussed herein.

The example computer system 800 includes one or more processing units (generally processor 802). The processor 802 may include, for example, a central processing unit (CPU), a graphics processing unit (GPU), a digital signal processor (DSP), a control system, a state machine, one or more application-specific integrated circuits (ASICs), one or more radio-frequency integrated circuits (RFICs), or any combination of these. The computer system 800 also includes a main memory 804. The computer system 800 may further include a storage unit 816. The processor 802, memory 804 and the storage unit 816 communicate via a bus 808.

In addition, the computer system 800 may include a static memory 806, a graphics display 810 (e.g., to drive a plasma display panel (PDP), a liquid crystal display (LCD), or a projector). The computer system 800 may also include an alphanumeric input device 812 (e.g., a keyboard), a cursor control device 817 (e.g., a mouse, a trackball, a joystick, a motion sensor, or other pointing instrument), a signal generation device 818 (e.g., a speaker), and a network interface device 820, which also are configured to communicate via the bus 808.

The storage unit 816 includes a machine-readable medium 822 on which is stored instructions 824 (e.g., software) embodying any one or more of the methodologies or functions described herein. For example, the instructions 824 may include the functionalities of modules of one or more of the online shared charter platform 140, the client devices 110 of FIG. 1, the machine for performing the process 600 of FIG. 6, or the machine for performing the process 700 of FIG. 7. The instructions 824 may also reside, completely or at least partially, within the main memory 804 or within the processor 802 (e.g., within a processor's cache memory) during execution thereof by the computer system 800. The main memory 804 and the processor 802 also constitute machine-readable media. The instructions 824 may be transmitted or received over a network 826 via the network interface device 820.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure. Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof. Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non transitory, tangible computer readable storage medium and may include any embodiment of a computer program product or other data combination described herein. Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method for automatically extracting and utilizing commercial flight information, the method comprising:
accessing, by an online shared charter platform, a data object from an external data platform, the data object being associated with a user of the online shared charter platform;
identifying, from the accessed data object, a commercial flight booking of the user;
attempting, by a set of template-based parsers executed by the online shared charter platform, to extract a set of parser-based structured commercial flight attributes from the commercial flight booking;
responsive to determining that the set of template-based parsers failed to produce a validated set of parser-based structured commercial flight attributes, inputting the identified commercial flight booking into a machine-learned model trained to output a set of model-based structured commercial flight attributes, wherein the machine-learned model is guided by a structured data template defining a machine-readable schema for causing the set of model-based structured commercial flight attributes to conform to the structured data template;
storing the parser-based or model-based structured commercial flight attributes as a structured commercial flight dataset in a datastore accessible to a matching engine of the online shared charter platform;
matching, by the matching engine, the structured commercial flight dataset with an available empty leg flight based on geographic and temporal matching constraints; and
transmitting, by the online shared charter platform, a notification comprising the available empty leg flight to a client device associated with the user in response to determining that the available empty leg flight satisfies a matching criterion relative to the structured commercial flight dataset.

2. The computer-implemented method of claim 1, wherein the data object comprises at least one of an email message or a calendar event, and wherein the external data platform comprises at least one of an email service or a calendar service associated with the account of the user.

3. The computer-implemented method of claim 1, wherein accessing the data object from the external data platform comprises:
subscribing to a push-notification channel exposed by the external data platform that publishes identifiers for newly created or updated data objects associated with the account of the user, and responsive to receiving a notification, retrieving corresponding data objects using the published identifiers.

4. The computer-implemented method of claim 1, wherein accessing the data object from the external data platform comprises:
transmitting the one or more API calls to the external data platform using an authenticated session for the account of the user and including a search query over metadata and content fields of data objects to specify at least one of: (i) subject keywords; (ii) sender domains associated with airline or travel providers; or (iii) text patterns indicative of itinerary content; and
receiving, in response to the transmitted API calls, one or more data objects that match the search query.

5. The computer-implemented method of claim 1, wherein the set of template-based parsers include a plurality of provider-specific parsers respectively associated with booking providers, and wherein attempting to extract the set of parser-based structured commercial flight attributes comprises:
selecting, from the plurality of provider-specific parsers, a parser keyed to the identified commercial flight booking based on at least one of a booking provider domain match, a subject-line pattern, a body-text pattern, or a markup-structure signature;
applying, by the selected parser, predetermined extraction rules to extract values for flight attributes from the identified commercial flight booking;
validating the extracted flight attribute values against a predefined schema characterizing required fields and associated permissible values; and
outputting, as the validated set of parser-based structured commercial flight attributes, a machine-readable structured commercial flight dataset that, for each flight leg, includes a flight identifier, departure attributes, and arrival attributes.

6. The computer-implemented method of claim 1, wherein the structured data template includes validation rules for each of a plurality of fields included in the set of model-based structured commercial flight attributes.

7. The computer-implemented method of claim 1, further comprising:
training the machine-learned model using a training dataset comprising pairs of data objects and corresponding validated sets of structured commercial flight attributes, the training using the validated attributes as supervision targets by, for each pair, providing the data object as input and updating model parameters to minimize a loss between predicted structured attributes of the machine-learned model and the corresponding validated attributes.

8. The computer-implemented method of claim 1, wherein the matching comprises:
mapping an origin and a destination of the commercial flight booking and the available empty leg flight to respective geographic clusters defined as preconfigured sets of proximate airports; and
applying dual time-window constraints including: (i) a commercial departure time within a window defined relative to the available empty leg fight's departure window; and (ii) a commercial arrival time within a window defined relative to an arrival interval derived from the available empty leg fight's departure window and a duration value of the available empty leg fight.

9. The computer-implemented method of claim 8, wherein, responsive to multiple commercial flights of multiple users satisfying the geographic clustering and the dual time-window constraints for the available empty leg fight:
computing, by the matching engine, a proposed departure time based on a median of departure times of the multiple commercial flights while constraining the proposed departure time to the empty leg's departure window.

10. The computer-implemented method of claim 1, further comprising:
evaluating operator-configurable constraints for the available empty leg booking, including a minimum revenue threshold; and
responsive to determining that the operator-configurable constraints for the available empty leg booking are satisfied, automatically transmitting, by the online shared charter platform, the notification comprising the available empty leg flight to the client device.

11. The computer-implemented method of claim 1, further comprising:
generating a flight-opportunity record corresponding to the available empty leg flight, the flight-opportunity record including proposed flight parameters determined for the available empty leg flight;
transmitting the flight-opportunity record to a client device associated with an operator of the available empty leg flight; and
responsive to receiving an approval from the operator client for the proposed flight parameters, automatically transmitting the notification comprising the available empty leg flight to the client device associated with the user.

12. A non-transitory computer-readable storage medium storing instructions that, when executed by one or more processors, cause an online shared charter platform to perform operations comprising:
accessing a data object from an external data platform, the data object being associated with a user of the online shared charter platform;
identifying, from the accessed data object, a commercial flight booking of the user;
attempting, by a set of template-based parsers executed by the online shared charter platform, to extract a set of parser-based structured commercial flight attributes from the commercial flight booking;
responsive to determining that the set of template-based parsers failed to produce a validated set of parser-based structured commercial flight attributes, inputting the identified commercial flight booking into a machine-learned model trained to output a set of model-based structured commercial flight attributes, wherein the machine-learned model is guided by a structured data template defining a machine-readable schema for causing the set of model-based structured commercial flight attributes to conform to the structured data template;
storing the parser-based or model-based structured commercial flight attributes as a structured commercial flight dataset in a datastore accessible to a matching engine of the online shared charter platform;
matching, by the matching engine, the structured commercial flight dataset with an available empty leg flight based on geographic and temporal matching constraints; and
transmitting a notification comprising the available empty leg flight to a client device associated with the user in response to determining that the available empty leg flight satisfies a matching criterion relative to the structured commercial flight dataset.

13. The non-transitory computer-readable storage medium of claim 12, wherein the data object comprises at least one of an email message or a calendar event, and wherein the external data platform comprises at least one of an email service or a calendar service associated with the account of the user.

14. The non-transitory computer-readable storage medium of claim 12, wherein the set of template-based parsers include a plurality of provider-specific parsers respectively associated with booking providers, and wherein attempting to extract the set of parser-based structured commercial flight attributes comprises:
selecting, from the plurality of provider-specific parsers, a parser keyed to the identified commercial flight booking based on at least one of a booking provider domain match, a subject-line pattern, a body-text pattern, or a markup-structure signature;
applying, by the selected parser, predetermined extraction rules to extract values for flight attributes from the identified commercial flight booking;
validating the extracted flight attribute values against a predefined schema characterizing required fields and associated permissible values; and
outputting, as the validated set of parser-based structured commercial flight attributes, a machine-readable structured commercial flight dataset that, for each flight leg, includes a flight identifier, departure attributes, and arrival attributes.

15. The non-transitory computer-readable storage medium of claim 12, wherein the instructions further cause the online shared charter platform to perform an operation comprising:
training the machine-learned model using a training dataset comprising pairs of data objects and corresponding validated sets of structured commercial flight attributes, the training using the validated attributes as supervision targets by, for each pair, providing the data object as input and updating model parameters to minimize a loss between predicted structured attributes of the machine-learned model and the corresponding validated attributes.

16. The non-transitory computer-readable storage medium of claim 12, wherein the matching comprises:
mapping an origin and a destination of the commercial flight booking and the available empty leg flight to respective geographic clusters defined as preconfigured sets of proximate airports; and
applying dual time-window constraints including: (i) a commercial departure time within a window defined relative to the available empty leg fight's departure window; and (ii) a commercial arrival time within a window defined relative to an arrival interval derived from the available empty leg fight's departure window and a duration value of the available empty leg fight.

17. The non-transitory computer-readable storage medium of claim 16, wherein the instructions further cause the online shared charter platform to perform an operation comprising, responsive to multiple commercial flights of multiple users satisfying the geographic clustering and the dual time-window constraints for the available empty leg fight:
computing, by the matching engine, a proposed departure time based on departure times of the multiple commercial flights while constraining the proposed departure time to the empty leg's departure window.

18. The non-transitory computer-readable storage medium of claim 12, wherein the instructions further cause the online shared charter platform to perform operations comprising:
evaluating operator-configurable constraints for the available empty leg booking, including a minimum revenue threshold; and
responsive to determining that the operator-configurable constraints for the available empty leg booking are satisfied, automatically transmitting, by the online shared charter platform, the notification comprising the available empty leg flight to the client device.

19. The non-transitory computer-readable storage medium of claim 12, wherein the instructions further cause the online shared charter platform to perform operations comprising:
generating a flight-opportunity record corresponding to the available empty leg flight, the flight-opportunity record including proposed flight parameters determined for the available empty leg flight;
transmitting the flight-opportunity record to a client device associated with an operator of the available empty leg flight; and
responsive to receiving an approval from the operator client for the proposed flight parameters, automatically transmitting the notification comprising the available empty leg flight to the client device associated with the user.

20. A system, comprising:
at least one memory; and
at least one processor coupled with the at least one memory, the at least one memory storing code comprising instructions that, when executed by the at least one processor, cause an online shared charter platform to perform operations comprising:
accessing a data object from an external data platform, the data object being associated with a user of the online shared charter platform;
identifying, from the accessed data object, a commercial flight booking of the user;
attempting, by a set of template-based parsers executed by the online shared charter platform, to extract a set of parser-based structured commercial flight attributes from the commercial flight booking;
responsive to determining that the set of template-based parsers failed to produce a validated set of parser-based structured commercial flight attributes, inputting the identified commercial flight booking into a machine-learned model trained to output a set of model-based structured commercial flight attributes, wherein the machine-learned model is guided by a structured data template defining a machine-readable schema for causing the set of model-based structured commercial flight attributes to conform to the structured data template;
storing the parser-based or model-based structured commercial flight attributes as a structured commercial flight dataset in a datastore accessible to a matching engine of the online shared charter platform;
matching, by the matching engine, the structured commercial flight dataset with an available empty leg flight based on geographic and temporal matching constraints; and
transmitting a notification comprising the available empty leg flight to a client device associated with the user in response to determining that the available empty leg flight satisfies a matching criterion relative to the structured commercial flight dataset.
